(19) United States
(12) Patent Application Publication
(10) Pub. No.: US 2023/0322199 A1
(43) Pub. Date: Oct. 12, 2023

(54) VEHICLE CONTROLLER AND VEHICLE CONTROL METHOD

(71) Applicant: HONDA MOTOR CO., LTD., Tokyo (JP)

(72) Inventors: Yusuke Yoshimura, Tokyo (JP); Takayuki Ozawa, Tokyo (JP)

(21) Appl. No.: 18/177,180

(22) Filed: Mar. 2, 2023

(30) Foreign Application Priority Data
Mar. 30, 2022 (JP) 2022-057691

(51) Int. Cl. B60W 10/30; B60R 16/03; B60H 1/00; B60W 10/26

(52) U.S. Cl. CPC B60W 10/30; B60H 1/00778; B60R 16/03; B60W 10/26; B60W 2520/04; B60W 2710/305

(57) ABSTRACT

A vehicle controller includes: an identifying unit that identifies a parking location of a vehicle; and a control unit that controls power supply to in-vehicle devices in response to operation on a power switch of the vehicle, the control unit maintains the power supply to a target in-vehicle device, which is at least one of the in-vehicle devices, during a predetermined target duration time after the vehicle is parked and the power switch is turned off, and the target duration time is determined depending on the parking location of the vehicle that is identified by the identifying unit.

### INCORPORATION BY REFERENCE

The present application claims priority under 35 U.S.C.§119 to Japanese Patent Application No. 2022-057691 filed on Mar. 30, 2022. The content of the application is incorporated herein by reference in its entirety.

### BACKGROUND OF THE INVENTION

### Field of the Invention

The present invention relates to a vehicle controller and a vehicle control method.

### Description of the Related Art

Japanese Patent Laid-Open No. 2010-141822 discloses a monitoring camera device using an in-vehicle camera. While an ignition switch is turned off, this monitoring camera device periodically supplies power to the in-vehicle camera to monitor the surroundings of an own vehicle; and every time a moving object (e.g., a suspicious person) is detected in a captured video, the monitoring camera device switches the in-vehicle camera to an always-on mode.

There might be possible scenarios in which power supply inside a vehicle is desired to be maintained after a vehicle user leaves a vehicle, such as the case of using an in-vehicle camera for the purpose of monitoring the vehicle and the case in which the vehicle user temporarily leaves the vehicle for shopping or the like. For example, in the case of an in-vehicle air conditioner that takes a relatively long time to be started up, it is more convenient for the vehicle user to keep the air conditioner turned on for a certain time length after the vehicle user gets off the vehicle rather than to turn off the air conditioner every time the vehicle user temporarily gets off the vehicle. However, when the air conditioner is left in a turned-on state for a long time after the vehicle user gets off the vehicle, the power consumption of a vehicle battery unfavorably increases.

### SUMMARY OF THE INVENTION

An object of the present invention is to maintain a power supply state of an in-vehicle device for an appropriate time length after a vehicle user gets of a vehicle.

In order to solve the above problems, the present application aims to improve operability of a vehicle. The present application also promotes improvement of traffic safety, to thereby contribute to development of sustainable transportation systems.

One aspect of the present invention is a vehicle controller including: an identifying unit that identifies a parking location of a vehicle; and a control unit that controls power supply to in-vehicle devices of the vehicle in response to operation on a power switch of the vehicle, the control unit maintains the power supply to a target in-vehicle device, which is at least one of the in-vehicle devices, during a predetermined target duration time after the vehicle is parked and the power switch is turned off, and the target duration time is determined depending on the parking location of the vehicle that is identified by the identifying unit.

According to another aspect of the present invention, the identifying unit identifies the parking location based on a surrounding image of the vehicle that is acquired by an in-vehicle camera of the vehicle.

According to another aspect of the present invention, the identifying unit identifies the parking location of the vehicle based on map data storing a parking area that is at least one range on a map and location information regarding a location where the vehicle is parked.

According to another aspect of the present invention, the vehicle controller further includes a setting unit that sets a reference time used as a reference of the target duration time, the setting unit sets, for each parking location, a value based on statics of elapsed time after a vehicle user turns off the power switch until the vehicle user turns on the power switch as the reference time for the parking location, and the control unit controls the power supply to the target in-vehicle device using the target duration time calculated based on the reference time.

According to another aspect of the present invention, the control unit acquires a temperature difference between a temperature in a vehicle cabin of the vehicle and an environment temperature outside the vehicle when the vehicle is parked, and sets the target duration time to be longer as the temperature difference is larger.

According to another aspect of the present invention, the target in-vehicle device includes an air conditioner in the vehicle cabin of the vehicle and/or an in-vehicle device that performs operation of using a display device.

Another aspect of the present invention is a vehicle control method performed by a computer, the method includes: a step of identifying a parking location of a vehicle; and a step of controlling power supply to in-vehicle devices of the vehicle in response to operation on a power switch of the vehicle, in the controlling step, the power supply to a target in-vehicle device, which is at least one of the in-vehicle devices, is maintained during a predetermined target duration time after the vehicle is parked and the power switch is turned off, and the target duration time is determined depending on the parking location of the vehicle that is identified in the identifying step.

According to the present invention, it is possible to maintain a power supply state of an in-vehicle device for an appropriate time length after a vehicle user gets off a vehicle.

### BRIEF DESCRIPTION OF THE DRAWINGS

FIG. 1 is a view showing a configuration of a control system of a vehicle, including a central ECU that is a vehicle controller according to an embodiment of the present invention;

FIG. 2 is a view showing a configuration of the central ECU;

FIG. 3 is a view showing an example of a reference image DB;

FIG. 4 is a view showing an example of an area table;

FIG. 5 is a view showing an example of a reference time table; and

FIG. 6 is a flow chart showing processing procedure of power supply control on a target in-vehicle device, in the central ECU.

### DETAILED DESCRIPTION OF THE PREFERRED EMBODIMENTS

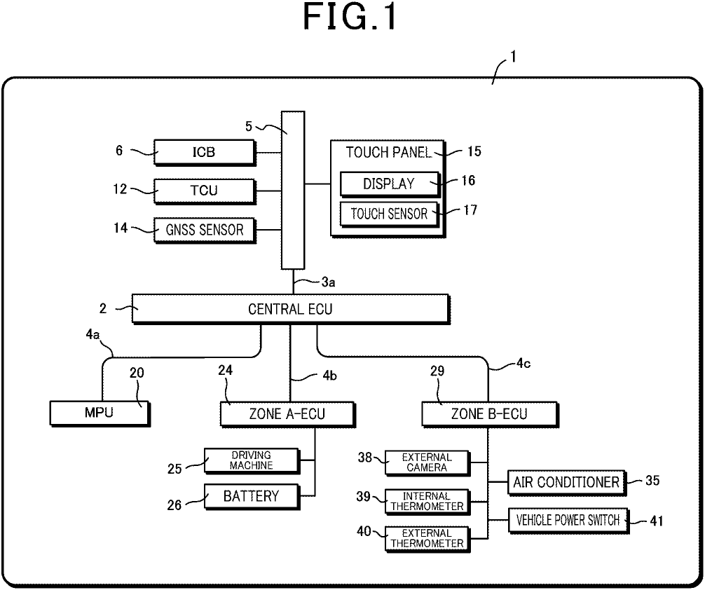

FIG. 1 is a view showing a control system 1 of a vehicle.

The control system 1 includes a central ECU 2 that performs general control and information processing of the vehicle. The central ECU 2 is connected to communication lines including a first communication line 3a and second communication lines 4a, 4b, 4c. The central ECU 2 realizes a function of a gateway that manages transmitting and receiving of communication data between these communication lines. The central ECU 2 also executes OTA (over the air) management. The OTA management includes control regarding processing of downloading update programs for in-vehicle devices mounted in the vehicle from a server outside the vehicle and processing of applying downloaded update programs to the in-vehicle devices. In the present embodiment, the central ECU 2 also operates as a vehicle controller that controls power supply to the in-vehicle devices, particularly in response to operation of a vehicle power switch 41 (described later) performed by a vehicle user. That is, the central ECU 2 corresponds to the vehicle controller in the present disclosure.

The first communication line 3a and the second communication lines 4a, 4b, 4c are composed of buses that perform communication conforming to standards, such as CAN and the Ethernet (registered trademark), or by communication lines that perform P2P (peer to peer) communication. It should be noted that the first communication line may include a plurality of communication lines 3a, 3b, 3c that performs communication based on the same standards, or may include a plurality of communication lines 3a, 3b, 3c that performs communication based on different standards. The same applies to the second communication lines 4a, 4b, 4c.

An ICB (infotainment control box) 6 is connected to the first communication line 3a via an in-vehicle connection link 5.

In addition, a TCU (telematics control unit) 12, a GNSS (global navigation satellite system) sensor 14, and a touch panel 15 are connected to the in-vehicle connection link 5. The TCU 12 is a wireless communication device having a transmitter and a receiver and conforming to the telecommunication standards of mobile communication systems. The touch panel 15 includes a display 16 and a touch sensor 17.

An ICB 6 is an IVI (in-vehicle infotainment)-ECU. The ICB 6 provides vehicle occupants with various information and entertainments, using the GNSS sensor 14, the touch panel 15, and/or non-illustrated speakers, microphones, and others.

The in-vehicle connection link 5 includes a plurality of communication transmission lines conforming to various telecommunication standards. The in-vehicle connection link 5 may include, for example, a plurality of network transmission paths. In this case, the plurality of network transmission paths may be connected to each other via a device having a gateway function or the like. In addition, the in-vehicle connection link 5 may include a transmission path for performing P2P communication. Various communication buses that perform network communication conforming to various standards can be adopted as the network transmission paths. The standards of this type include, for example, CAN, the Ethernet, USB (universal serial bus), LIN (local interconnect network), and LVDS (low voltage differential signaling), and other standards may also be employed.

A MPU (map positioning unit) 20 is connected to the second communication line 4a. The MPU 20 identifies a position of the own vehicle on a high definition map.

A Zone A-ECU 24 is connected to the second communication line 4b. The Zone A-ECU 24 is connected to a driving machine 25 and a battery 26. The driving machine 25 is a motor or an internal combustion engine that drives a vehicle, for example.

A Zone B-ECU 29 is connected to the second communication line 4c. An air conditioner 35, an external camera 38 that images the environment outside the own vehicle, an internal thermometer 39 that measures a temperature of a vehicle cabin of the own vehicle, and an external thermometer 40 that measures a temperature outside the own vehicle are connected to the Zone B-ECU 29. A vehicle power switch 41 that controls power-on/off of the entire own vehicle is connected to the Zone B-ECU 29, as well. For example, when the driving machine 25 is a motor, the vehicle power switch 41 can also be used as a switch of power supply to the motor, and can be used as an ignition-key switch when the driving machine 25 is an internal combustion engine.

Hereinafter, a vehicle including the control system 1 will be referred to as an own vehicle, and a user using the own vehicle will be referred to as a vehicle user.

As described above, in the present embodiment, the central ECU 2 operates as the vehicle controller that controls the power supply to the in-vehicle device in response to the operation on the vehicle power switch 41 performed by the vehicle user. Particularly, in the present embodiment, the central ECU 2 identifies a parking location of the own vehicle when the own vehicle is parked, and even after the vehicle power switch 41 is turned off once, the central ECU 2 maintains the power supply to at least one of the in-vehicle devices during a target duration time determined depending on the identified parking location.

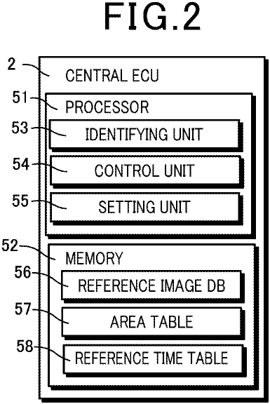

FIG. 2 is a view showing the configuration of a part of the central ECU 2, which performs operation as the vehicle controller.

The central ECU 2 includes a processor 51 and a memory 52. The memory 52 is composed of a volatile and/or non-volatile semiconductor memory, for example.

The processor 51 is a computer including a CPU, for example. The processor 51 includes an identifying unit 53, a control unit 54, and a setting unit 55 as functional elements or functional units. These functional elements can be realized by executing a program stored in the memory 52 by the computer processor 51, for example. The computer program can be stored in any computer-readable storage medium. Alternatively, all or some of the functional elements included in the processor 51 may be each composed of hardware including one or more electronic circuit components.

The identifying unit 53 identifies a parking location of the own vehicle when the own vehicle is parked. For example, the identifying unit 53 determines that the own vehicle is parked when a shift lever and a parking brake included in a steering operation device 27 are set to a parking position and the vehicle power switch 41 is turned off. The parking location identified by the identifying unit 53 can be expressed by a name of a store or facility related to the location where the own vehicle is parked (for example, a “convenience store A”, a “convenience store B”, a “supermarket C”, a “kindergarten D”, etc.), or by a name of a parking area within a position range on a map (for example, an “area E”, a “point F”, etc.) set by the setting unit 55 described later.

For example, when it is determined that the own vehicle is parked, the identifying unit 53 acquires an image of the surrounding environment of the own vehicle from the external camera 38 and identifies the parking location of the own vehicle. Specifically, the identifying unit 53 determines whether or not the acquired image acquired by the external camera 38 includes a reference image characteristic of a predetermined store or facility (for example, an image of a logo mark of a store signboard or characters of a facility name). This determination can be carried out, for example, by pattern matching between the acquired image and the reference image, in accordance with the prior art.

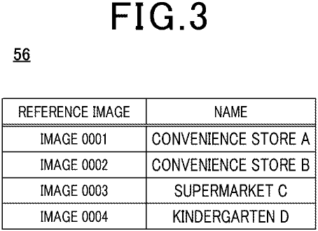

The predetermined reference image can be associated with a name such as a store name or a facility name (for example, the above-described “convenience store A”, “convenience store B”, “supermarket C”, “kindergarten D”, etc.) related to the reference image, and can be saved in a reference image DB (database) 56 stored in the memory 52. FIG. 3 is a view showing an example of the reference image DB 56. In the illustrated example, reference images of an “image 0001”, an “image 0002”, etc., illustrated in the left column are saved in association with respective names in the right column. Here, the “image 0001” or the like can be image data itself or an address of a storage location where the image data is saved. For example, when the acquired image acquired by the external camera 38 includes the “image 0001” that is a reference image characteristic of the convenience store A, the identifying unit 53 identifies the parking location as the “convenience store A”, by using the name associated with this reference image in the reference image DB (database) 56.

Alternatively, the identifying unit 53 identifies the parking location of the own vehicle based on map data recording a parking area that is at least one range on a map and location information on the location where the own vehicle is parked. The map data of the parking area can be set by the setting unit 55 described later and associated with any name indicating the parking area (for example, the “area E”, the “point F”, etc., described above), and can be saved in an area table 57 in the memory 52. The map data of the parking area can be expressed, for example, by location information (longitude and latitude, etc.,) on vertexes of the parking area that can be displayed as a polygon on the map. The map data of the parking area may be expressed by using a center position and a radius (or long and short radii) of a circular (or elliptical) parking area, instead of using the positions of the vertexes.

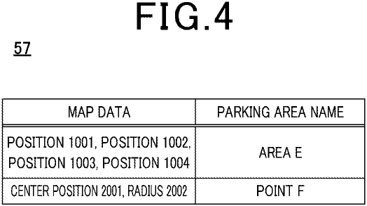

FIG. 4 is a view showing an example of the area table 57. In the illustrated example, map data shown in the left column is saved in association with respective names of corresponding parking areas in the right column. The map data of an “area E” includes four location coordinates: a “position 1001”, a “position 1002”, a “position 1003”, and a “position 1004”. This map data defines an area on the map corresponding to the “area E” in a rectangular shape. The map data of a “point F” includes one position coordinate: a “center position 2001”, and one distance: a “radius 2002”. This map data defines an area on the map corresponding to the “point F” in a circular shape.

When it is determined that own vehicle is parked, the identifying unit 53 acquires location information on the location where the own vehicle is parked from the GNSS sensor 14. The identifying unit 53 refers to the area table 57 based on the acquired location information, and determines whether or not the location where the own vehicle is parked is within a range of any parking area. When it is determined that the location where the own vehicle is parked is within the range of any parking area indicated in the map data shown in the area table 57, the identifying unit 53 identifies the current parking location, by using the name of the parking area, such as the “area E”, the “point F”, etc., associated with this area.

The control unit 54 controls the power supply to the in-vehicle devices of the own vehicle in response to the operation, performed by the vehicle user, on the vehicle power switch 41 of the own vehicle, which is acquired via the zone B-ECU 29. In the present embodiment, in particular, the control unit 54 maintains the power supply to the target in-vehicle device, which is at least one of the in-vehicle devices, during a predetermined target duration time depending on the parking location of the own vehicle identified by the identifying unit 53 even after the own vehicle is parked and the vehicle power switch 41 is turned off. For example, the target in-vehicle device may be selected and determined in advance from the in-vehicle devices having start-up time lengths longer than a predetermined time length. The present embodiment, the target in-vehicle device includes, for example, an air conditioner 35 in a vehicle cabin of the own vehicle and/or the ICB 6 as an in-vehicle device operated by using the touch panel 15 as a display device.

In general, as for the vehicle user, a time length until the vehicle user comes back after leaving the own vehicle varies depending on the parking location; for example, about 10 minutes at a convenience store for small shopping, about 30 minutes at a supermarket, or about 20 minutes for picking-up or dropping-off to school, kinder garden, or the like. In the central ECU 2 of the present embodiment, since the target duration time is determined depending on the parking location, the power supply state of the in-vehicle device after the vehicle user gets off the own vehicle can be maintained for an appropriate time length in accordance with, for example, the purpose or habitual behavior of the vehicle user at the concerned parking location.

Therefore, with the central ECU 2, the vehicle user, having come back to the own vehicle before the target duration time elapses, can quickly use the target in-vehicle device. In addition, the central ECU 2 maintains the power supply to the target in-vehicle device in a tuned-on state when the vehicle power switch 41 is turned on before the target duration time elapses; therefore, the frequency of turning-on and -off of the power supply is reduced. As a result, the service lives of the target in-vehicle device and the control unit 54 that turns on and off the power supply to the target in-vehicle device are increased.

Using a reference time as a reference of the target duration time, which is defined for each parking location by the setting unit 55 described later, the control unit 54 calculates the target duration time based on this reference time. Specifically, when the own vehicle is parked and the vehicle power switch 41 is turned off, the control unit 54 refers to a reference time table 58 in the memory 52 based on the current parking location identified by the identifying unit 53, and acquires the reference time corresponding the above identified parking location.

The control unit 54 may be configured to use the above acquired reference time as it is as the target duration time or to calculate and use a target duration time longer or shorter than the reference time based on other parameters. For example, the control unit 54 can acquire a temperature difference between a temperature inside the vehicle cabin of the own vehicle acquired by the internal thermometer 39 and an environmental temperature outside the own vehicle acquired by the external thermometer 40 when the own vehicle is parked. Then, the control unit 54 may set a target duration time longer than the above acquired reference time as the above acquired temperature difference (for example, an absolute value of the temperature difference) is larger. Accordingly, for example, in the summer or winter time when the own vehicle travels while the air conditioner is running, the air conditioner can be kept turned on for a longer time after the vehicle power switch 41 of the own vehicle is turned off; therefore, when the vehicle user, after getting off the own vehicle at the parking location and finishing what to do, comes back to the own vehicle, the vehicle cabin can be kept at a comfortable temperature.

For each parking location, the setting unit 55 sets the reference time of the target duration time during which the power supply to one of the in-vehicle devices should be maintained after the vehicle power switch 41 is turned off. Specifically, for each parking location, the setting unit 55 sets a value based on the statistics of elapsed time after the vehicle user turns off the vehicle power switch 41 until the vehicle user turns on the power switch, as a reference time for the concerned parking location. The statistics may be, for example, an average value, a median value, a mode value, a maximum value, or a minimum value of the elapsed time. Moreover, the above “value based on the statistics” may be a value of the statistics as it is or a value calculated from the statistics. For example, the setting unit 55 can set an average value of the above elapsed time, which is the statistics, as the reference time. Moreover, for example, the setting unit 55 may set a value obtained by multiplying any of the above statistics by a predetermined coefficient or a weighted average of part of the above statistics (e.g., mean, median, mode, etc.) as the reference time. The setting unit 55 associates the reference time thus set with the parking location, and saves this in the reference time table 58.

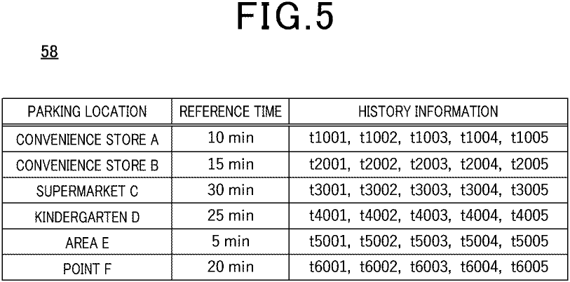

FIG. 5 is a view showing an example of the reference time table 58. As shown in FIG. 5, in the illustrated example, each row in the left column indicates a parking location, and a reference time for each parking location is defined in each row in the center column. The reference time in each row in the center column is defined, for each corresponding parking location, based on the elapsed time after the turning-off operation of the vehicle power switch 41 until the tuning-on operation thereof (hereinafter, referred to as an operation interval time of the turning-on/off operation), which has been carried out by the vehicle user. In the example of FIG. 4, the reference time in each row in the center column is defined based on an average value of the operation interval time (illustrated as “t1001”, “t1002”, etc.) of latest five tuning-on/off operations, indicated in each corresponding row of “history information” in the right column. When the own vehicle is parked and the parking location is identified, the setting unit 55 measures the operation interval time at this parking location, updates the history information regarding this parking location, and also updates the reference time based on the updated history information.

As described above, the control unit 54 refers to the reference time table 58 as shown in FIG. 5 when the own vehicle is parked and the vehicle power switch 41 is turned off, and acquires the reference time corresponding to the parking location identified by the identifying unit 53. Then, the control unit 54 calculates the target duration time based on, for example, a temperature difference between the inside and the outside of the own vehicle from the acquired reference time, and maintains the power supply to one or some of the in-vehicle devices after the vehicle power switch 41 is turned off, during the calculated target duration time.

The setting unit 55 also updates the reference image DB 56 in accordance with an instruction from the vehicle user. For example, in response to the instruction from the vehicle user using the touch panel 15 or the like, the setting unit 55 displays, on the touch panel 15, an image acquired by the external camera 38 at a location where the own vehicle is parked. On the touch panel 15, the vehicle user specifies diagonal points of a desired image part, such as a store signboard, on the displayed image, and inputs the name of this store. The setting unit 55 associates the image part specified above with the input name, and saves this in the reference image DB 56 as the reference image.

In accordance with an instruction from the vehicle user, the setting unit 55 creates map data for the parking area specified by the vehicle user, and creates or updates the area table 57. For example, in response to the instruction from the vehicle user using the touch panel 15 or the like, the setting unit 55 displays a map on the touch panel 15. The vehicle user specifies, on the map displayed on the touch panel 15, vertex positions of a polygon surrounding a desired parking area, and then enters the name of this parking area, and thereafter the vehicle user inputs the name of this parking area. The setting unit 55 associates the vertex positions above specified with the input name, and saves this in the area table 57 as the map data of this parking area. As described above, the map data may include a center position with a radius (or long and short radii) of the parking area in a circular (or elliptical) shape.

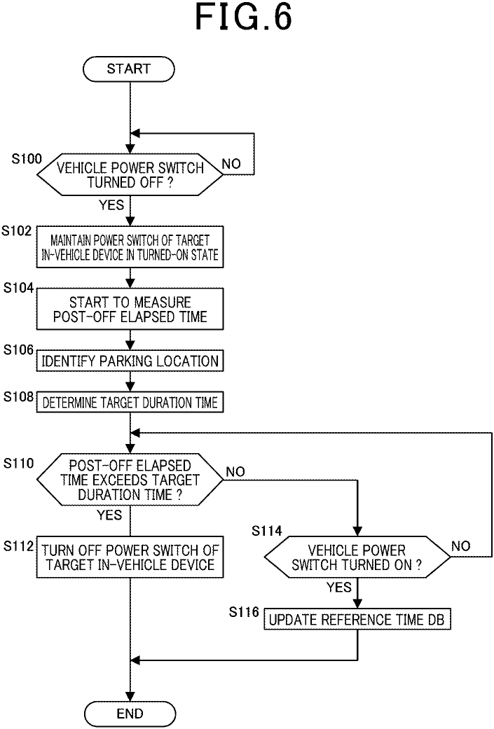

The operation procedure of the central ECU 2 will be described, hereinafter. FIG. 6 is a flow chart showing the processing procedure of the power supply control on the target in-vehicle device, in the central ECU 2. The processing shown in FIG. 6 is repeatedly executed.

When the processing is started, the control unit 54 first determines whether or not the own vehicle is parked and the vehicle power switch 41 is turned off (S100). When the vehicle power switch 41 is not turned off (NO in S100), the control unit 54 returns to step S100 and repeats the processing, and waits for the vehicle power switch 41 to be turned off. On the other hand, when the vehicle power switch 41 is turned off (YES in S100), the control unit 54 maintains the power supply to the target in-vehicle device (S102) that is predetermined. As for in-vehicle devices other than the target in-vehicle device, the control unit 54 stops or continues the power supply to all or some of the in-vehicle devices in accordance with the prior art.

Further, the control unit 54 starts to measure post-off elapsed time, which is elapsed time after the vehicle power switch 41 is turned off (S104). Subsequently, the identifying unit 53 identifies the parking location of the own vehicle (S106), and the control unit 54 determines the target duration time depending on the parking location identified by the identifying unit 53 (S108). As described above, for example, referring to the reference time table 58, from the reference time associated with the above parking location, the control unit 54 can calculate and determine the target duration time based on the temperature difference between the inside and the outside of the own vehicle.

Next, the control unit 54 determines whether or not the post-off elapsed time has passed the target duration time (for example, whether or not the target duration time has been exceeded) (S110). Then, when the post-off elapsed time has passed the target duration time (YES in S110), the control unit 54 turns off the power supply to the target in-vehicle device (S112), and terminates this processing.

On the other hand, when the post-off elapsed time has not passed the target duration time (NO in S110), the control unit 54 determines whether or not the vehicle power switch 41 is turned on (S114). Then, when the vehicle power switch 41 is not turned on (NO in S114), the control unit 54 returns to S110 to repeat the processing, and waits until the post-off elapsed time passes the target duration time.

On the other hand, when the vehicle power switch 41 is turned on (YES in S114), based on the post-off elapsed time when the vehicle power switch 41 is turned on (i.e., the operation interval time), the setting unit 55 updates the reference time, corresponding to the current parking location saved in the reference time table (S116), and thereafter the setting unit 55 terminates this processing.

### Other Embodiments

The target in-vehicle device may be specified by the vehicle user. For example, in accordance with an instruction from the vehicle user using the touch panel 15 or the like, the setting unit 55 displays a list of in-vehicle devices as candidates of the target in-vehicle device on the touch panel 15. The vehicle user may select an in-vehicle device from the above list displayed on the touch panel 15, and the setting unit 55 may instruct the control unit 54 to set the selected in-vehicle device as the target in-vehicle device.

The identifying unit 53 may identify the parking location of the own vehicle based on map information used for a car navigation or the like. For example, in the case in which location information or area information regarding the parking location, such as facility, is indicated on the above map information, when a position where the own vehicle is parked is included in this parking location, the identifying unit 53 may identify the parking location of the own vehicle, by using the name of the facility or the like associated with this parking location in the above map information. Alternatively, when the name of facility or a place (e.g., a store, a station, a park, etc.) existing within a range with a predetermined distance (e.g., several tens of meters) from the position where the own vehicle is parked is indicated on the above map information, the identifying unit 53 may identify the parking location of the own vehicle, by using the name of this facility or this place.

It should be noted that the present invention is not limited to the configurations of the above-described embodiments, and can be implemented in various forms without departing from the gist of the present invention.

### Configurations Supported by the Above Embodiments

The above-described embodiments support the following configurations.

### (Configuration 1)

A vehicle controller including: an identifying unit that identifies a parking location of a vehicle; and a control unit that controls power supply to in-vehicle devices of the vehicle in response to operation on a power switch of the vehicle, the control unit maintaining the power supply to a target in-vehicle device, which is at least one of the in-vehicle devices, during a predetermined target duration time after the vehicle is parked and the power switch is turned off, and the target duration time being determined depending on the parking location of the vehicle that is identified by the identifying unit.

According to the vehicle controller of Configuration 1, the target duration time is determined depending on the parking location, the power supply state of the in-vehicle device after the vehicle user gets off the own vehicle can be maintained for an appropriate time length based on, for example, the purpose and the habitual behavior of the vehicle user at this parking location.

### (Configuration 2)

The vehicle controller as set forth in Configuration 1, wherein the identifying unit identifies the parking location based on a surrounding image of the vehicle that is acquired by an in-vehicle camera of the vehicle.

According to the vehicle controller of Configuration 2, the parking location can be identified with high accuracy by using the surrounding image.

### (Configuration 3)

The vehicle controller as set forth in Configuration 1 or 2, wherein the identifying unit identifies the parking location of the vehicle based on map data storing a parking area that is at least one range on a map and location information regarding a location where the vehicle is parked.

According to the vehicle controller of Configuration 3, the parking location can be identified with high accuracy even when the own vehicle is parked in a parking lot extending over a certain range.

### (Configuration 4)

The vehicle controller as set forth in any one of Configurations 1 to 3, further including a setting unit that sets a reference time used as a reference of the target duration time, wherein the setting unit sets, for each parking location, a value based on statics of elapsed time after a vehicle user turns off the power switch until the vehicle user turns on the power switch as the reference time for the parking location, and the control unit controls the power supply to the target in-vehicle device using the target duration time calculated based on the reference time.

According to the vehicle controller of Configuration 4, since the reference time based on the actual behavior of the vehicle user in each parking location is used, it is possible to set the duration target time more suitable for the vehicle user.

### (Configuration 5)

The vehicle controller as set forth in any one of Configurations 1 to 4, wherein the control unit acquires a temperature difference between a temperature in a vehicle cabin of the vehicle and an environment temperature outside the vehicle when the vehicle is parked, and sets the target duration time to be longer as the temperature difference is larger.

According to the vehicle controller of Configuration 5, for example, in the summer and winter time when the own vehicle travels with the air conditioner running, the air conditioner can be kept turned on for a longer time after the vehicle power switch is turned off; therefore, when the vehicle user, having gotten off the own vehicle at the parking location, comes back to the own vehicle after finishing what to do, the vehicle cabin can be kept at a comfortable temperature.

### (Configuration 6)

The vehicle controller as set forth in any one of Configurations 1 to 5, wherein the target in-vehicle device includes an air conditioner in the vehicle cabin of the vehicle and/or an in-vehicle device that performs operation of using a display device.

According to the vehicle controller of Configuration 6, an in-vehicle device, which takes a long time for start-up after the power supply is started, is set as the target in-vehicle device; therefore, it is possible to reduce time for completing the start-up over all in-vehicle devices when the vehicle user turns on the vehicle power switch again at the parking location.

### (Configuration 7)

A vehicle control method performed by a computer, the method including: a step of identifying a parking location of a vehicle; and a step of controlling power supply to in-vehicle devices of the vehicle in response to operation on a power switch of the vehicle, in the controlling step, the power supply to a target in-vehicle device, which is at least one of the in-vehicle devices, being maintained during a predetermined target duration time after the vehicle is parked and the power switch is turned off, and the target duration time being determined depending on the parking location of the vehicle that is identified in the identifying step.

According to the vehicle control method of Configuration 7, since the target duration time is determined depending on the parking location, the power supply state of the in-vehicle device after the vehicle user gets off the own vehicle can be maintained for an appropriate time length, for example, based on the purpose or the habitual behavior of the vehicle user at that parking location.

### REFERENCE SIGNS LIST

1 control system, 2 central ECU, 3a first communication line, 4a, 4b, 4c second communication line, 5 in-vehicle connection link, 6 ICB, 12 TCU, 14 GNSS sensor, 15 touch panel, 16 display, 17 touch sensor, 20 MPU, 24 zone A-ECU, 25 driving machine, 26 battery, 29 zone B-ECU, 35 air conditioner, 38 external camera, 39 internal thermometer, 40 external thermometer, 41 vehicle power switch, 51 processor, 52 memory, 53 identifying unit, 54 control unit, 55 setting unit, 56 reference image DB, 57 area table, 58 reference time table

What is claimed is:

1. A vehicle controller comprising:
an identifying unit that identifies a parking location of a vehicle; and
a control unit that controls power supply to in-vehicle devices of the vehicle in response to operation on a power switch of the vehicle,
the control unit maintaining the power supply to a target in-vehicle device, which is at least one of the in-vehicle devices, during a predetermined target duration time after the vehicle is parked and the power switch is turned off, and
the target duration time being determined depending on the parking location of the vehicle that is identified by the identifying unit.

2. The vehicle controller according to claim 1, wherein
the identifying unit identifies the parking location based on a surrounding image of the vehicle that is acquired by an in-vehicle camera of the vehicle.

3. The vehicle controller according to claim 1, wherein
the identifying unit identifies the parking location of the vehicle based on map data storing a parking area that is at least one range on a map and location information regarding a location where the vehicle is parked.

4. The vehicle controller according to claim 1, further comprising a setting unit that sets a reference time used as a reference of the target duration time, wherein
the setting unit sets, for each parking location, a value based on statics of elapsed time after a vehicle user turns off the power switch until the vehicle user turns on the power switch as the reference time for the parking location, and
the control unit controls the power supply to the target in-vehicle device using the target duration time calculated based on the reference time.

5. The vehicle controller according to claim 1, wherein
the control unit
acquires a temperature difference between a temperature in a vehicle cabin of the vehicle and an environment temperature outside the vehicle when the vehicle is parked, and
sets the target duration time to be longer as the temperature difference is larger.

6. The vehicle controller according to claim 1, wherein
the target in-vehicle device includes an air conditioner in the vehicle cabin of the vehicle and/or an in-vehicle device that performs operation of using a display device.

7. A vehicle control method performed by a computer, the method comprising:
a step of identifying a parking location of a vehicle; and
a step of controlling power supply to in-vehicle devices of the vehicle in response to operation on a power switch of the vehicle,
in the controlling step, the power supply to a target in-vehicle device, which is at least one of the in-vehicle devices, being maintained during a predetermined target duration time after the vehicle is parked and the power switch is turned off, and
the target duration time being determined depending on the parking location of the vehicle that is identified in the identifying step.
